(19) United States
(12) Patent Application Publication
(10) Pub. No.: US 2010/0269469 A1
(43) Pub. Date: Oct. 28, 2010

(54) Rake Implement and Process for Removing Vegetation from a Body of Water

(76) Inventor: Gary D. Klobukowski, Shelby Township, MI (US)

Correspondence Address: GREGORY T. ZALECKI, 12900 HALL ROAD, SUITE 400, STERLING HEIGHTS, MI, 48313, US

(21) Appl. No.: 12/428,607

(22) Filed: Apr. 23, 2009

(51) Int. Cl. A01D 44/00; A01D 91/04

(52) U.S. Cl. 56/8

(57) ABSTRACT

A rake implement, which can be attached to a tractor to remove vegetation from a body of water, is comprised of a triangular frame, three arms, a hitch receiver, a rake arm and a plurality of tines. The arms extend from the vertices of the triangular frame and meet at the hitch receiver. The hitch receiver slidingly holds the rake arm. The rake arm is locked to the hitch receiver to set the length of the rake implement. The tines are transversely attached to the rake arm forming a rake like structure. The triangular frame is attached to the three-way hitch of a tractor. The rake implement and tractor can be used to remove vegetation from the body of water. The length of the rake implement is sufficient to allow the tines to engage all of the undesirable vegetation without the tractor entering the body of water.

### BACKGROUND

Bodies of water are very common within our geographical landscape. They include lakes and ponds with many different depths, shore configurations and slopes. It is not uncommon for vegetation to be growing within such bodies of water—both in the water and on the shoreline. The vegetation is often considered to be undesirable weeds or other aquatic plants. It interferes with the aesthetics of the shoreline. It also interferes with uses of the body of water for such purposes as fishing or swimming. Weeds growing within a body of water near the shoreline deter many people from entering the water, whether it be to swim or for other miscellaneous purposes such as retrieving golf balls which have entered a pond. Persons owning property which encloses or abuts one or more bodies of water often deem the vegetation to be unsightly. Their preference is that the shoreline and the water near the shoreline be devoid of vegetation.

Despite this preference, most bodies of water have shorelines exhibiting the natural growth of vegetation. It is difficult to remove this vegetation. One could use a rake and manual labor to remove the vegetation. However, this is a very difficult and time-consuming task. Further, much of the vegetation is beyond the reach of typical rakes. There are presently no known tractor implements which are adapted to perform this vegetation removal function. Using pre-existing tractor implements would involve having the tractor either enter the water or muddy areas on the shoreline. Either option is often not feasible. Even if one of these options is attempted with the tractor, vegetation growth beyond the reach of the tractor implement would remain.

There is a need for a rake implement which could be attached to a tractor and used to remove vegetation from a body of water. This implement would have a variable length so that it could be used to reach vegetation at variable distances from the shoreline without having the tractor enter the water. It would be attachable to the three-way hitch of a tractor. It would be angled with respect to the hitch such that it could be used to remove vegetation from bodies of water having varying slopes from the shoreline.

### SUMMARY

The rake implement and the process for removing vegetation from a body of water described herein satisfies these needs. The rake implement is comprised of a frame, a plurality of arms, a hitch receiver, a rake arm and a plurality of rake times. The frame is adapted to be attached to a tractor. Preferably, the frame is triangular and can be pivotally attached at each vertex to the hitch of a tractor by way of pivot pins. The arms extend from the frame. The upper arm should slope downward. The arms are attached to the hitch receiver. The arms should have a triangular configuration with respect to each other and the triangular frame. In other words, any two arms and the part of the triangular frame to which they are attached form a triangular configuration. The hitch receiver is adapted to receive and hold the rake arm. This can be accomplished by utilizing a rake arm with a square cross-section wherein the square cross-section fits within and slides within a square opening within the hitch receiver. The length of the rake implement can be adjusted by adjusting the degree to which the rake arm is inserted into the hitch receiver. Once the desired rake implement length is obtained, the rake arm is locked to the hitch receiver. A hitch pin inserted through the rake arm and the hitch receiver can be used to perform this locking function. The rake tines are attached to the distal end of the rake arm. This is the end of the rake arm opposite the end which is inserted into the hitch receiver.

In order to use the rake implement to remove vegetation from a body of water, it is attached to a tractor. Ideally, the rake implement is attached to the three-way hitch of a tractor. The tractor and the rake implement are positioned near the body of water. The surface contact points of the tractor wheels define a plane. The operative ends of the tines are raised above this plane. The tines are extended over a patch of vegetation by repositioning the tractor and the rake implement such that the patch of vegetation lies between the tines and the tractor. The operative ends of the tines are then lowered below the plane previously described. As a result, the tines engage the vegetation and the soil within which the vegetation is embedded. The vegetation is removed from the soil by propelling the tractor such that the vegetation is pulled from the soil within which the vegetation is embedded. After the vegetation has been removed from the soil within which it had been embedded, the tines are raised in order to remove the vegetation from the tines.

### DRAWINGS

These and other features, aspects, and advantages of the present invention will become better understood with regard to the following description, appended claims, and accompanying drawings where:

FIG. 1 is a perspective view of a rake implement attached to the three-point hitch of a tractor.

FIG. 2 is a broken away top perspective view of the rake implement of FIG. 1 showing an enlarged view of the rake arm, tine beam and rake tines.

FIG. 3 is a side perspective view of the rake implement of FIG. 1.

FIG. 4 is a perspective view of the rake implement and tractor of FIG. 1 prior to the rake tines being engaged with vegetation in a body of water.

FIG. 5 is a perspective view of the rake implement and tractor of FIG. 1 after the rake tines have been engaged with the vegetation.

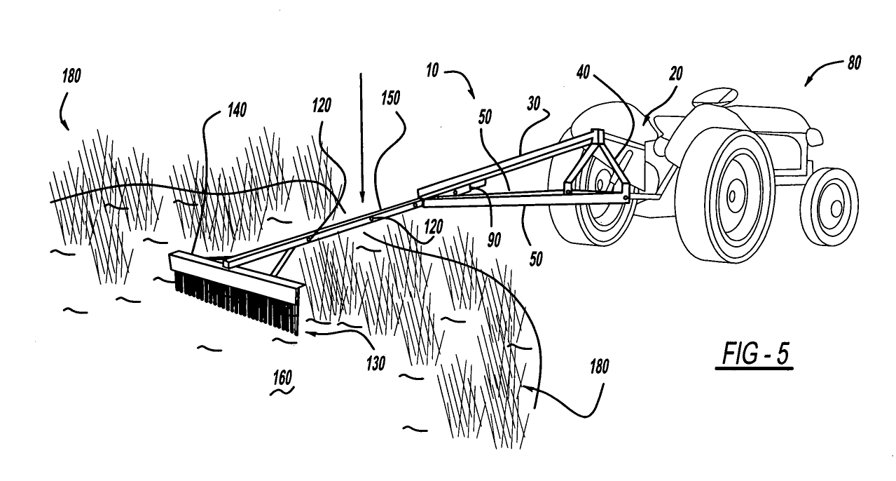

FIG. 6 is a perspective view of the rake implement and tractor of FIG. 1 showing vegetation being removed from the body of water.

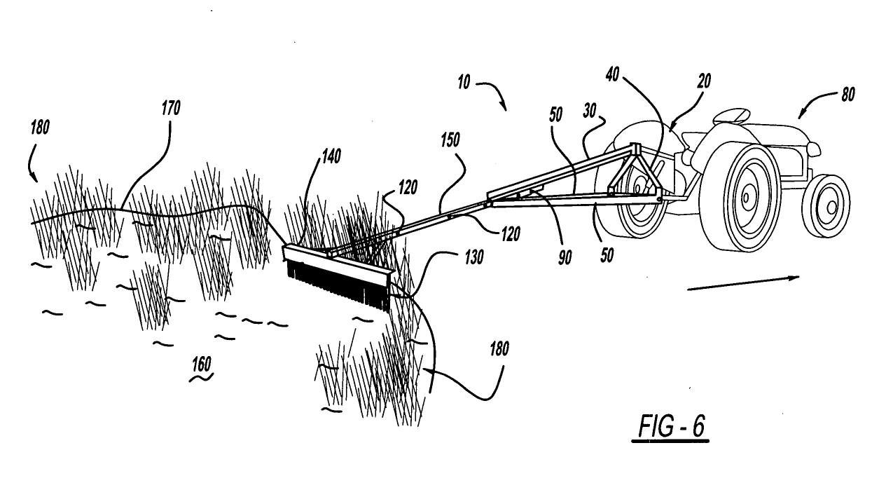

FIG. 7 is a perspective view of the rake implement and tractor of FIG. 1 showing vegetation which has been removed from the body of water while it is still engaged with the rake tines.

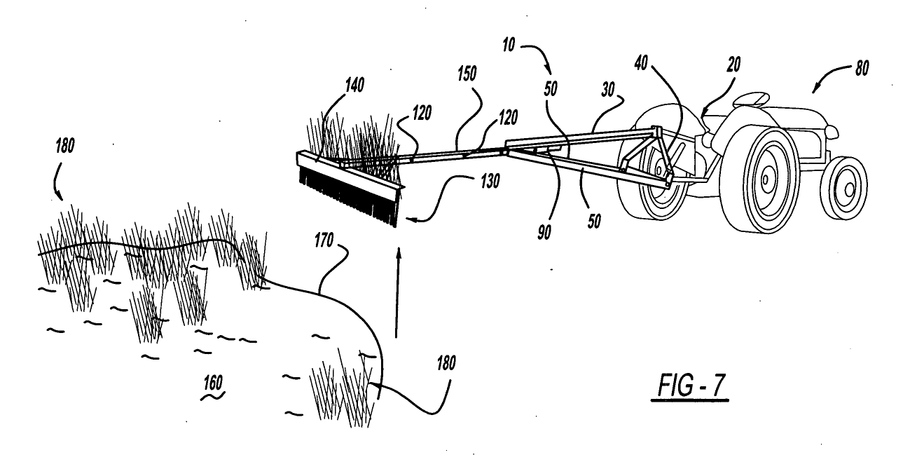

FIG. 8 is a perspective view of the rake implement and tractor of FIG. 1 showing the vegetation after it has been removed from the rake tines.

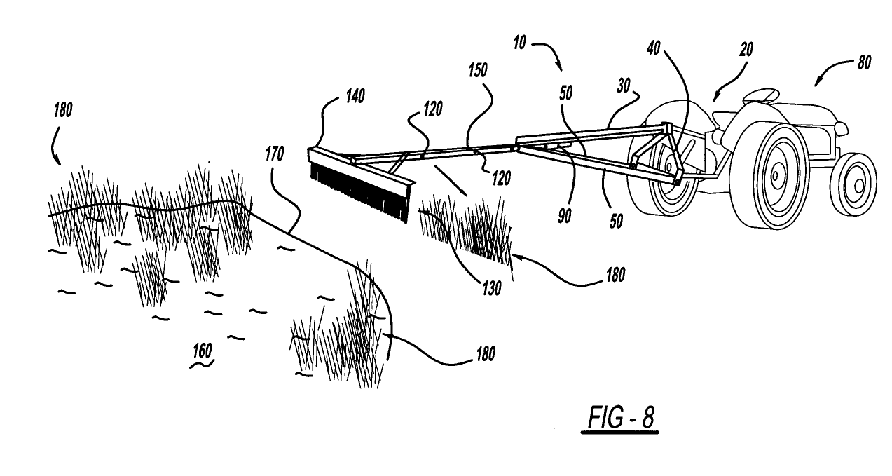

FIG. 9 is a perspective view of a rake implement attached to the three-point hitch of a tractor.

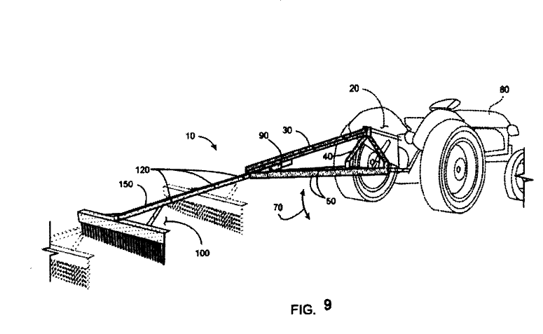

FIG. 10 is a broken away top perspective view of the rake implement of FIG. 9 showing an enlarged view of the rake arm, tine beam and rake tines.

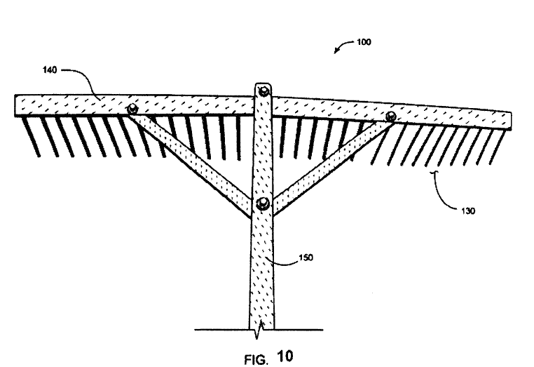

FIG. 11 is a side perspective view of the rake implement of FIG. 9.

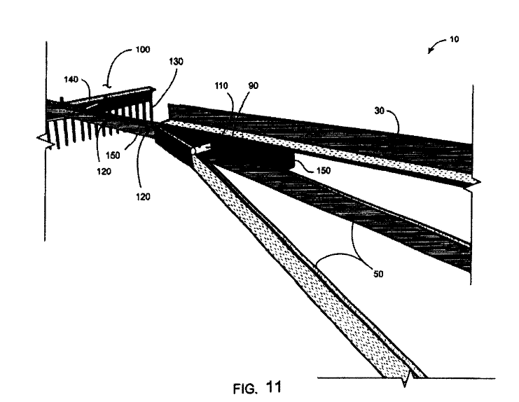

### DESCRIPTION

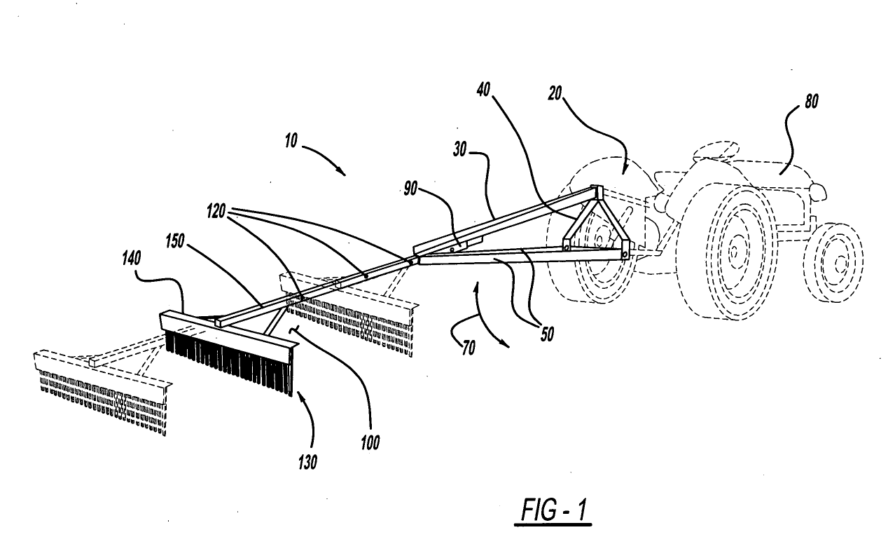

The preferred embodiment of a rake implement 10 is shown in FIGS. 1-3. It is intended to be attached to the three-way hitch 20 of a tractor 80. The rake implement 10 is comprised of a triangular frame 40, an upper arm 30, a first lower arm 50, a second lower arm 50, a hitch receiver 90, a rake arm 150, and a plurality of rake tines 130.

The triangular frame 40 is adapted to be pivotally attached to the hitch 20 of a tractor 80. A typical tractor hitch 20 has three pivotal points of attachment. These points form a triangle. The two bottom points are adapted to fit over pivot pins. Similarly, the upper point is adapted to have a pivot pin inserted through it. The bottom vertices of the triangular frame 40 are each equipped with a horizontally oriented pivot pin which engages with the tractor hitch 20. The upper vertex of the triangular frame 40 has a pair of aligned openings through which a pivot pin fits. The upper vertex of the triangular frame 40 is secured to the tractor hitch 20 with such a pivot pin. The pivot pins may be secured with fasteners such as nuts or cotter pins. The term upper vertex of the triangular frame 40 refers to the highest vertical vertex when the triangular frame 40 is attached to the tractor hitch 20. The term bottom vertices of the triangular frame 40 refers to the two low vertices of the triangular frame 40 as shown in FIG. 1. The triangular frame 40 should be constructed from a strong metal such as steel or aluminum.

The upper arm 30 may be constructed from angle iron or steel. Aluminum is also a suitable material. The upper arm 30 extends from the upper/top vertex of the triangular frame 40, as shown in FIG. 1. The first lower arm 50 extends from a lower vertex of the triangular frame 40. The second lower arm 50 extends from the other lower vertex of the triangular frame 40. The lower arms 50, as well as the upper arm 30, meet at and are attached to the hitch receiver 90. The lower arms 50 should be fabricated from the same material from which the upper arm 30 is fabricated. The lower arms 50 form a triangular configuration with respect to each other. Each lower arm 50 also forms a triangular configuration with the upper arm 30. When the tractor 80 and the tines 130 rest upon the same flat surface, with the rake implement 10 attached to the hitch 20 of the tractor 80, the lower arms 50 should rest within a substantially horizontal plane.

The upper arm 30 should be oriented with a downward angle. This is illustrated in FIG. 1. The downward angle is measured along the upper arm 30 from the hitch 20 toward the tines 130. The angle is measured with respect to a horizontal reference frame. The downward angle is such that when the rake implement 10 is attached to the hitch 20 of a tractor 80, the tractor 80 and the tines 130 rest upon the same flat surface, as shown in FIG. 1. Thus the end of the upper arm 30 which is distal to the hitch 20 is lower than the end of the upper arm 30 which is proximal to the hitch 20. Because of this downward angle, as the rake implement 10 is lengthened the tines 130 will be positioned more and more below a virtual plane upon which the tractor 80 wheels rest. Thus, lengthening or shortening the rake implement 10 allows the tines 130 to reach the bottoms of various bodies of water having different depths and shoreline slopes.

The hitch receiver 90 should be constructed from the same material from which the lower arms 50 and the upper arm 30 are fabricated. Preferably, the hitch receiver 90 has a square opening. This square opening is sized such that the rake arm 150 may slide within the hitch receiver 90, but will not rotate within the hitch receiver 90. Rotation is prevented by a square cross-section presented by the rake arm 150. The longitudinal axis of the hitch receiver 90 should be parallel to the longitudinal axis of the upper arm 30. This will allow the proper angle of attack between the rake arm 150 and the surface to be raked.

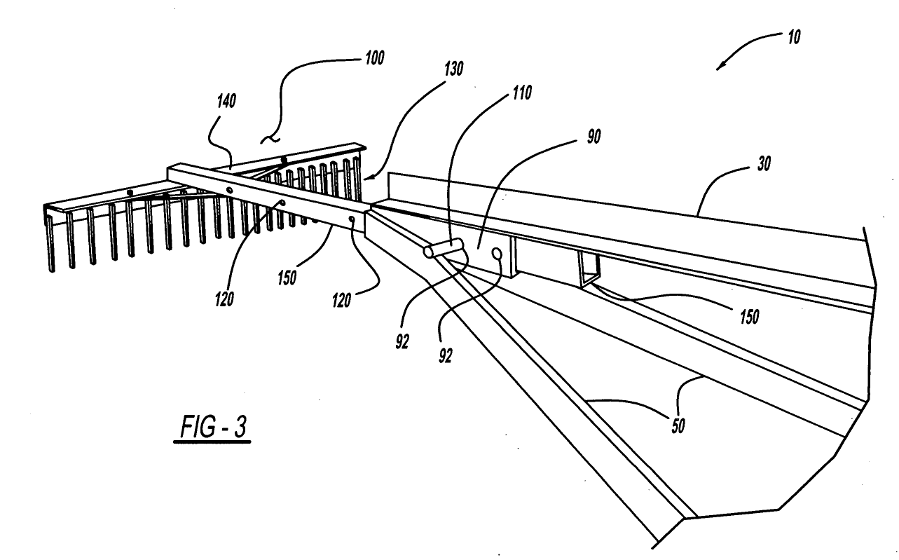

The rake arm 150 should be constructed from tubular steel or aluminum. As stated, the rake arm 150 has a cross-section which is shaped such that the rake arm 150 will slide within, but not rotate within, the hitch receiver 90. The rake arm 150 should have at least one pair of aligned openings 120 as indicated in FIG. 3. Each pair of rake arm openings 120 is aligned such that it will receive a hitch pin 110. The hitch receiver 90 also has at least one pair of aligned openings 92. The hitch receiver aligned openings 92 are also aligned such that each pair of aligned openings will receive a hitch pin 110. Further, each pair of rake arm aligned openings 120 and each pair of hitch receiver openings 92 are configured such that their respective openings 120, 92 are alignable with each other so that a hitch pin 110 may be inserted through the aligned openings to secure the rake arm 150 to the hitch receiver 90. The overall length of the rake implement 10 may be adjusted by selecting different pairs of aligned rake arm openings 120 and aligned hitch receiver openings 92 for mating with the hitch pin 110. The rake arm 150 is attached to the hitch receiver 90 by inserting the hitch pin 110 through a set of aligned rake arm openings 120 and aligned hitch receiver openings 92.

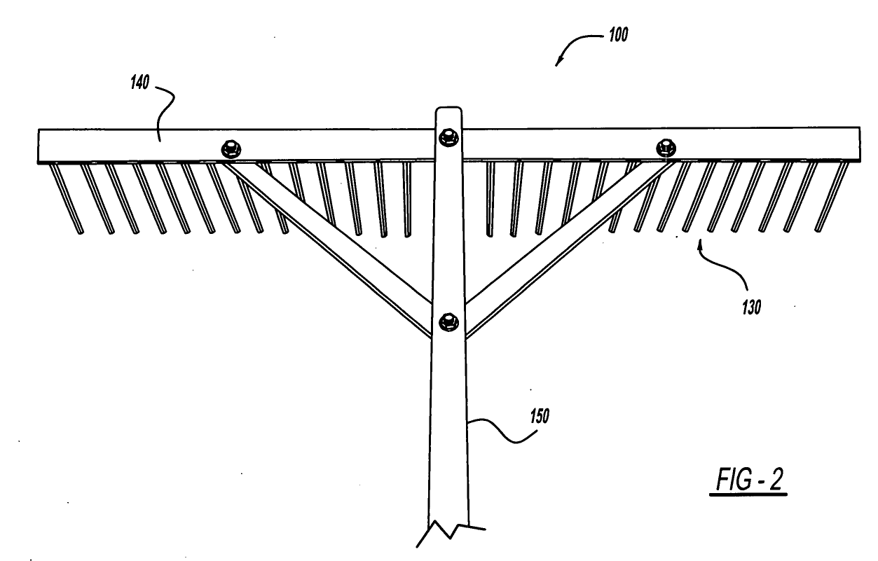

The other end (the end opposite the hitch receiver 90) of the rake arm 150 is attached to a tine beam 140. The tine beam 140 is transversely oriented with respect to the rake arm 150. In other words, the tine beam 140 and the rake arm 150 form a right angle, as shown in FIG. 3. The purpose of the tine beam 140 is to support the rake tines 130. The tine beam 140 should be constructed from steel or aluminum. Braces should be installed between the rake arm 150 and the tine beam 140, as shown in FIG. 2, in order to maintain the structural integrity and the angle between the tine beam 140 and the rake arm 150.

The plurality of rake tines 130 are attached to the tine beam 140 to form a rake like structure, as shown in FIG. 2. The tines 130 should be fabricated from steel or aluminum. They are adapted to be capable of performing a raking action upon a ground surface when the triangular frame 40 is attached to the hitch 20 of the tractor 80.

The wheels of the tractor 80 each contact the ground surface. These contact points define a plane. The plane can be thought of as a virtual floor upon which the tractor 80 sets. The tractor hitch 20 has at least two operative positions—an upper position and a lower position. The components of the rake implement 10 are configured such that the operative ends of the tines 140 are below this plane when the tractor hitch 20 is in the lower (first) position and such that the operative ends of the tines 140 are above this plane when the tractor hitch 20 is in the upper (second) position. The operative ends of the tines 140 are the pointed ends which dig into the soil. Additionally, the length of the rake implement 10, when it is attached to the hitch 20 of the tractor 80, is configured such that the operative ends of the tines 140 may extend below the bottom ground surface of a body of water 160 while the tractor wheels are displaced away from the body of water 160. In other words, the tines 140 of the rake implement 10 are capable of penetrating the bottom/soil surface of a body of water 160, even though no part of the tractor 80 is within the body of water 160.

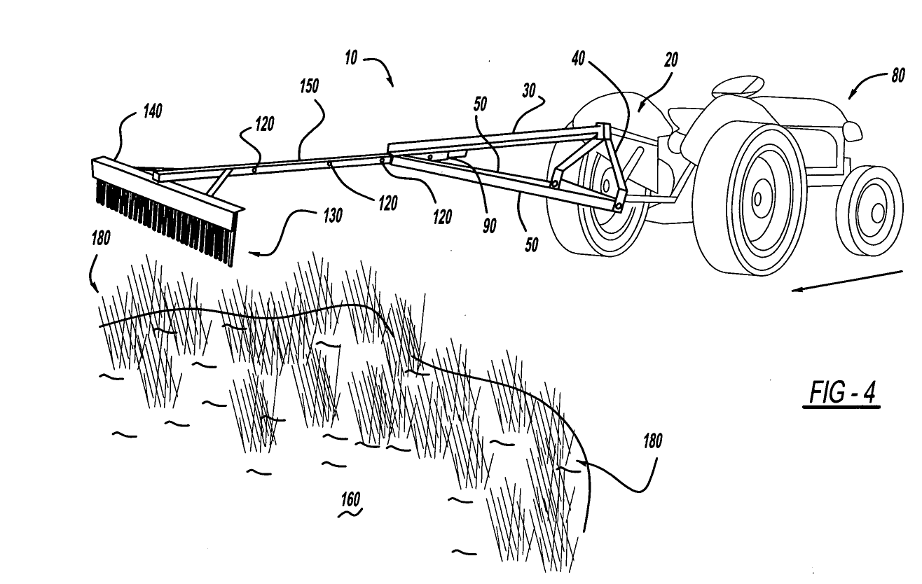

The described rake implement 10 is intended to be used with a tractor 80 to implement a process for removing vegetation 180 from a body of water 160. The term vegetation includes weeds and other plant life, especially aquatic plants. FIG. 4 shows a body of water 160. The body of water 160 has a shoreline 170. Vegetation 180 often grows within a body of water 160, as well as the shoreline 170. The vegetation 180 is unsightly. It also interferes with some uses of the body of water 160, such as fishing and swimming. Typically, the vegetation 180 grows near the shoreline 170. As the distance from the shoreline 170 increases and the depth of the body of water 160 increases, the vegetation 180 disappears or is not visible to a person standing on the shore. Therefore, what is needed is a long rake which can be inserted into the body of water 160 and, with considerable force, pulled to remove the visible vegetation 180. The rake implement 10 attached to a tractor 80 provides this function.

The first step of the process for removing vegetation 180 from a body of water 160 is to select a tractor 80. Next, a rake implement 10, as previously described, is selected. The rake implement 10 is attached to the tractor 80. The triangular frame 40 of the rake implement 10 is pivotally attached to the hitch 20 of the tractor 80.

The object of the process is to keep the tractor 80 out of the body of water 160, while extending the rake implement tines 130 to the outer limits of the undesirable vegetation 180 (i.e., the distance from the shore wherein the undesirable vegetation 180 ends). In order to accomplish this, the overall length of the rake implement 10 may need to be adjusted. The length is adjusted by removing the hitch pin 110 from the hitch receiver 90 and the rake arm 150. The length of the rake implement 10 is adjusted by sliding the rake arm 150 within the hitch receiver 90 until an approximate desired overall length is obtained. A pair of rake arm openings 120 are aligned with a pair of hitch receiver openings 92 and the rake arm 150 is locked to the hitch receiver 90 by inserting the hitch pin 110 through the openings 92, 120. Thus, a desired length of the rake implement 10 is set. The overall length of the rake implement 10 should be set so that desired patches of vegetation 180 may be removed without having the tractor 80 wheels enter the body of water 160.

The tractor 80 and the rake implement 10 attached to it are positioned near the body of water 160. The operative ends of the tines 130 are raised above the plane defined by the surface contact points of the tractor 80 wheels. This is the plane as previously described. The tines 130 are extended over a patch of vegetation 180. This is accomplished by repositioning the tractor 80 and the rake implement 10 such that the patch of vegetation 180 which is desired to be removed lies between the tines 130 and the tractor 80. The operative ends of the tines 130 are lowered below said plane. As a result, the tines 130 engage the vegetation 180 and the soil within which the vegetation 180 is embedded. The vegetation 180 is removed from the soil by propelling the tractor 80 away from the body of water 160. This results in the vegetation 180 being pulled from the soil within which the vegetation 180 is embedded. After the vegetation 180 is removed from the body of water 160 to a desirable location, the tines 130 are raised and the vegetation is removed from the tines 130. This can usually be accomplished by operating the hitch 20 controls of the tractor 80. On occasion, vegetation 180 may need to be manually removed from the tines 130.

The rake implement 10 and the process described herein facilitate the removal of vegetation from a body of water to an extent not heretofore achievable. The length of the rake implement allows vegetation areas not previously reachable to be reached. At the same time, this length permits the tractor to remain outside of the body of water and also outside of any muddy shoreline which may surround the body of water. The rake implement and process can be used to remove vegetation from all types of bodies of water. These include lakes and ponds with varying depths, slopes and shoreline configurations.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. A rake implement comprising:
(a) a triangular frame adapted to be pivotally attached to the hitch of a tractor;
(b) an upper arm extending from a vertex of the triangular frame;
(c) a first lower arm extending from a vertex of the triangular frame;
(d) a second lower arm extending from a vertex of the triangular frame;
(e) a hitch receiver for receiving and holding a rake arm;
(f) wherein the upper arm, the first lower arm and the second lower arm are attached to the hitch receiver such that the hitch receiver is aligned with the upper arm;
(g) a rake arm inserted into the hitch receiver and secured to the hitch receiver; and
(h) a plurality of rake tines transversely attached to the rake arm such that the tines are capable of performing a raking action upon a ground surface when the triangular frame is attached to the hitch of the tractor;
(i) wherein the rake implement is adapted such that the operative ends of the tines are below a plane defined by the surface contact points of the tractor wheels when the tractor hitch is in one position and such that the operative ends of the tines are above a plane defined by the surface contact points of the tractor wheels when the tractor hitch is in a second position; and
(j) wherein the length of the rake implement when it is attached to the hitch of the tractor is adapted such that the operative ends of the tines may extend below the bottom ground surface of a body of water while the tractor wheels are displaced away from the body of water.

2. The rake implement of claim 1, wherein the rake arm has at least one pair of aligned openings, wherein the hitch receiver has at least one pair of aligned openings, wherein the aligned openings of the rake arm are alignable with the aligned openings of the hitch receiver such that the rake arm may be adjustably attached to the hitch receiver by a hitch pin inserted through a pair of aligned rake arm openings and a pair of aligned hitch receiver openings, whereby the length of the rake implement is adjustable.

3. The rake implement of claim 1, wherein the longitudinal axis of the hitch receiver is parallel to the longitudinal axis of the upper arm.

4. The rake implement of claim 1, wherein the upper arm is oriented with a downward angle, measured along the upper arm from the tractor hitch toward the tines and measured with respect to a horizontal reference frame, when the rake implement is attached to the hitch of a tractor and the tractor and tines rests upon the same flat surface, whereby the end of the upper arm distal to the hitch is lower than the end of the upper arm proximal to the hitch.

5. A process for removing vegetation from a body of water, said process comprising the steps of:
(a) selecting a tractor;
(b) selecting a rake implement comprising:
(i) a frame adapted to be attached to a tractor;
(ii) a plurality of arms extending from the frame;
(iii) a hitch receiver for receiving and holding a rake arm;
(iv) wherein the arms are attached to the hitch receiver;
(v) a rake arm inserted into the hitch receiver and secured to the hitch receiver; and
(vi) a plurality of rake tines attached to the rake arm;
(c) attaching the rake implement to the tractor;
(d) positioning the tractor and the rake implement near the body of water;
(e) raising the operative ends of the tines above a plane defined by the surface contact points of the tractor wheels;
(f) extending the tines over a patch of vegetation by repositioning the tractor and the rake implement such that the patch of vegetation lies between the tines and the tractor;
(g) lowering the operative ends of the tines below the plane defined by the surface contact points of the tractor wheels such that the tines engage the vegetation and the soil within which the vegetation is embedded;
(h) removing the vegetation from the soil by propelling the tractor such that the vegetation is pulled from the soil within which the vegetation is embedded; and
(i) raising the tines to remove the vegetation from the tines.

6. The process for removing vegetation from a body of water of claim 5, wherein:
(a) the tractor has a hitch;
(b) the frame is triangular and pivotally attached to the hitch of the tractor;
(c) the plurality of arms extending from the frame is comprised of an upper arm extending from a vertex of the triangular frame, a first lower arm extending from a vertex of the triangular frame, and a second lower arm extending from a vertex of the triangular frame;
(d) wherein the upper arm, the first lower arm and the second lower arm are attached to the hitch receiver such that the hitch receiver is aligned with the upper arm;
(e) wherein the plurality of rake tines is transversely attached to the rake arm such that the tines are capable of performing a raking action upon a ground surface when the triangular frame is attached to the hitch of the tractor;
(f) wherein the rake implement is adapted such that the operative ends of the tines are below a plane defined by the surface contact points of the tractor wheels when the tractor hitch is in one position and such that the operative ends of the tines are above a plane defined by the surface contact points of the tractor wheels when the tractor hitch is in a second position; and
(g) wherein the length of the rake implement when it is attached to the hitch of the tractor is adapted such that the operative ends of the tines may extend below the bottom ground surface of a body of water while the tractor wheels are displaced away from the water.

7. The process for removing vegetation from a body of water of claim 5, wherein the rake arm has at least one pair of aligned openings, wherein the hitch receiver has at least one pair of aligned openings, wherein the aligned openings of the rake arm are alignable with the aligned openings of the hitch receiver such that the rake arm may be adjustably attached to the hitch receiver by a hitch pin inserted through a pair of aligned rake arm openings and a pair of aligned hitch receiver openings, whereby the length of the rake implement is adjustable.

8. The process for removing vegetation from a body of water of claim 5, wherein the longitudinal axis of the hitch receiver is parallel to the longitudinal axis of the upper arm.

9. The process for removing vegetation from a body of water of claim 7, further comprising the step of adjusting the length of the rake implement such that the patch of vegetation may be removed without having the tractor wheels enter the body of water.
